(19) United States
(12) Patent Application Publication
(10) Pub. No.: US 2019/0275540 A1
(43) Pub. Date: Sep. 12, 2019

(54) DEVICE FOR APPLYING A LIQUID MATERIAL TO A SUBSTRATE

(71) Applicant: Tremco Incorporated, Beachwood, OH (US)

(72) Inventors: Thomas Kevin MILO, Akron, OH (US); Mark E. CENTEA, Wadsworth, OH (US); Glenn Johnson, North Jackson, OH (US); Ge Wang, Solon, OH (US)

(21) Appl. No.: 16/299,377

(22) Filed: Mar. 12, 2019

Related U.S. Application Data
(63) Continuation of application No. 15/293,325, filed on Oct. 14, 2016.
(60) Provisional application No. 62/242,609, filed on Oct. 16, 2015.

(51) Int. Cl. B05B 9/06; B05B 9/00; B05B 1/20; B05B 13/00; B67D 7/02; B05B 9/04; B05B 12/00

(52) U.S. Cl. CPC B05B 9/06; B05B 9/007; B05B 1/20; B05B 3/18; B67D 7/0288; B05B 9/0403; B05B 12/004; B05B 13/005

(57) ABSTRACT

A dispensing system includes a mobile dispensing device, a fluid transport device, and a fluid supply module. The mobile dispensing device includes a dispensing mechanism carried by a first frame including a first track portion. The fluid transport device includes a second frame supported by at least one wheel for rolling movement of the second frame on the substrate, with the second frame including a second track portion. The fluid supply module includes a base member and at least one reservoir carried by the base member and connectable with the dispensing mechanism for dispensing a fluid stored in the at least one reservoir. The base member includes a third track portion selectively engageable with either one of the first and second track portions for releasable assembly of the fluid supply module with the corresponding one of the mobile dispensing device and the fluid transport device.

### CROSS-REFERENCE TO RELATED APPLICATION

The present application is a continuation of U.S. patent application Ser. No. 15/293,325, filed on Oct. 14, 2016, for DEVICE FOR APPLYING A LIQUID MATERIAL TO A SUBSTRATE, which claims priority to and all benefit of U.S. Provisional Patent Application Ser. No. 62/242,609, filed on Oct. 16, 2015, for DEVICE FOR APPLYING A LIQUID MATERIAL TO A SUBSTRATE, the entire disclosures of both of which are fully incorporated herein by reference.

### BACKGROUND

Coatings for roofs, flooring and other substrates are often applied by a mobile dispensing apparatus that carries one or more tanks of coating fluid to be dispensed, and a dispensing mechanism for applying the fluid or fluids to the substrate. The mobile dispensing apparatus is movable on the substrate during the dispensing operation to facilitate efficient application of the coating to a large area of the substrate.

### SUMMARY

According to an exemplary embodiment of the present application, a mobile dispensing device includes a frame, a dispensing mechanism carried by the frame, and a fluid supply module. The frame is supported by at least one wheel for rolling movement of the frame on a substrate. The frame includes a first track portion. The fluid supply module includes a base member and at least one reservoir carried by the base member and connectable with the dispensing mechanism for dispensing a fluid stored in the at least one reservoir. The base member includes a second track portion releasably engageable with the first track portion of the frame for releasable assembly of the fluid supply module with the frame.

According to another exemplary embodiment, a coating system includes a mobile dispensing device, a fluid transport device, and a fluid supply module. The mobile dispensing device includes a first frame and a dispensing mechanism carried by the first frame. The first frame is supported by at least one wheel for rolling movement of the first frame on a substrate, with the first frame including a first track portion. The fluid transport device includes a second frame supported by at least one wheel for rolling movement of the second frame on the substrate, with the second frame including a second track portion. The fluid supply module includes a base member and at least one reservoir carried by the base member and connectable with the dispensing mechanism for dispensing a fluid stored in the at least one reservoir. The base member includes a third track portion selectively engageable with either one of the first and second track portions for releasable assembly of the fluid supply module with the corresponding one of the mobile dispensing device and the fluid transport device.

According to another exemplary embodiment, a method for supplying fluid to a mobile dispensing device is also contemplated, in which the mobile dispensing device includes a frame supported by at least one wheel for rolling movement of the frame on a substrate and a dispensing mechanism carried by the first frame. In the exemplary method, a fluid transport device is provided, including a frame supported by at least one wheel for rolling movement of the second frame on the substrate, and a fluid supply module including a base member, a first track portion engaged with a second track portion of the fluid transport device frame, and at least one reservoir carried by the base member. The fluid transport device is moved to a loading position proximate the mobile dispensing device, such that the second track portion of the fluid transport device frame aligns with a third track portion on the mobile dispensing device frame. The first track portion of the fluid supply module is released from the second track portion of the fluid transport device frame. The fluid supply module is moved onto the mobile dispensing device frame, such that the first track portion of the fluid supply module engages the third track portion of the mobile dispensing device frame. The at least one reservoir is connected with the dispensing mechanism of the mobile dispensing device for dispensing a fluid stored in the at least one reservoir.

According to another exemplary embodiment, a dispensing device for dispensing at least a first fluid includes a frame, a dispensing mechanism carried by the frame, a first fluid reservoir supported by the frame and connected with the dispensing mechanism, a first load sensing mechanism, a first flow control mechanism, and a controller. The first load sensing mechanism is connected with the first fluid reservoir for generating first load data corresponding to a weight of a first fluid disposed in the first fluid reservoir. The first flow control mechanism is operable to control flow of the first fluid from the first fluid reservoir to the dispensing mechanism. The controller is in circuit communication with the first load sensing mechanism and with the first flow control mechanism. The controller is operable to measure a first flow rate of the first fluid based on changes to the first load data over a predetermined time period, to compare the first flow rate to first fluid parameters stored by the controller, and to control the first flow control mechanism to adjust the first flow rate to correspond with the first fluid parameters.

According to another exemplary embodiment, a dispensing device for dispensing a mixture of at least first and second fluids includes a frame, a dispensing mechanism carried by the frame, a mixing unit supported by the frame and connected with the dispensing mechanism, first and second fluid reservoirs, first and second flow control mechanisms, first and second flow control mechanisms, and a controller. The first and second fluid reservoirs are supported by the frame and connected with the mixing unit. The first and second flow control mechanisms are operable to control flow of first and second fluids from the first and second fluid reservoirs to the mixing unit. The first and second flow measuring mechanisms generate first and second data corresponding to first and second flow rates of the first and second fluids through the first and second flow control mechanisms. The controller is in circuit communication with the first and second flow measuring mechanisms and with the first and second flow control mechanisms. The controller is operable to receive the first and second data from the first and second flow measuring mechanisms, to compare the first and second data with first fluid and second fluid parameters stored by the controller, and to control the first and second flow control mechanisms to adjust the first and second flow rates to correspond with the first fluid and second fluid parameters.

According to another inventive aspect of the present application, a mobile dispensing device includes a frame, a dispensing mechanism, and at least one tank. The frame is supported by at least one wheel for rolling movement of the frame on a substrate. The dispensing mechanism includes a dispensing bar secured to a front end of the frame. The dispensing bar includes a plurality of nozzles. The dispensing bar is laterally slideable with respect to the frame, such that the dispensing bar is positionable in a laterally offset position in which at least one of the plurality of nozzles is positioned laterally outward of the frame. The at least one tank is supported by the frame and is connectable with the dispensing mechanism for dispensing a fluid stored in the at least one tank.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to provide examples of the principles of this invention.

FIG. 1 is a side perspective view of a mobile dispensing device, in accordance with an exemplary embodiment;

FIG. 2 is a front perspective view of the mobile dispensing device of FIG. 1, shown with the dispensing mechanism in a laterally offset position;

FIG. 2A is an enlarged perspective view of the dispensing mechanism of the mobile dispensing device of FIG. 1;

FIG. 3 is a partially exploded side perspective view of the mobile dispensing device of FIG. 1, shown with the fluid supply module separated from the mobile dispensing device frame;

FIG. 4 is a side perspective view of the fluid supply module of the mobile dispensing device of FIG. 1;

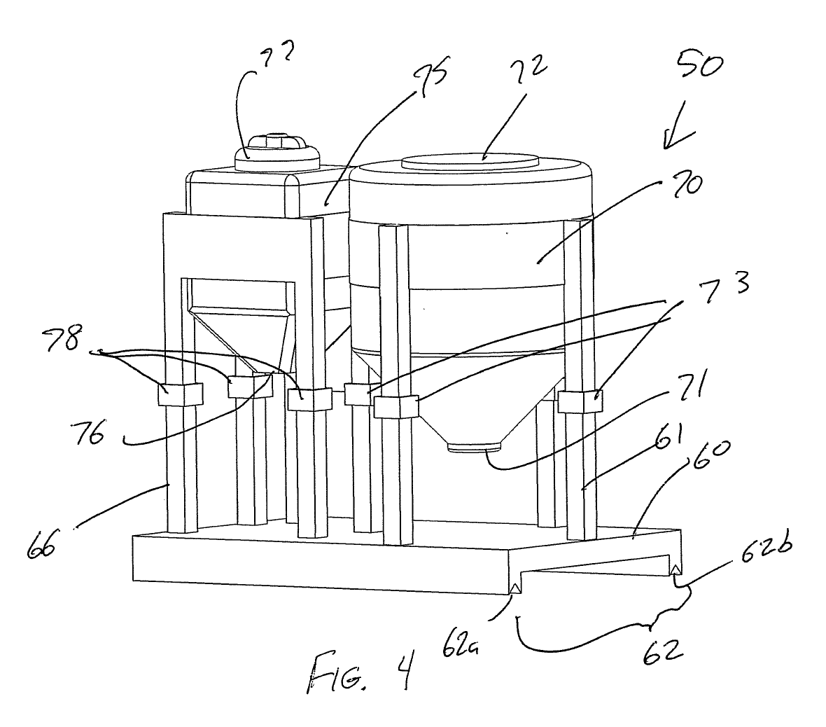

FIG. 5 is a perspective view of a dispensing system, in accordance with an exemplary embodiment; and

FIG. 6 is a perspective view of the fluid transport device of the dispensing system of FIG. 5.

### DETAILED DESCRIPTION

As described herein, when one or more components are described as being assembled, connected, joined, affixed, coupled, attached, or otherwise interconnected, such interconnection may be direct as between the components or may be indirect such as through the use of one or more intermediary components. Also as described herein, reference to a “member,” “component,” or “portion” shall not be limited to a single structural member, component, or element but can include an assembly of components, members or elements.

The Detailed Description merely describes exemplary embodiments and is not intended to limit the scope of the claims in any way. Indeed, the invention as claimed and described is broader than and unlimited by the exemplary embodiments, and the terms used in the claims have their full ordinary meaning. For example, while the specific embodiments described herein relate to devices, systems and methods for applying a liquid coating to a roofing substrate from a mobile dispensing cart movable on the roofing substrate, the inventive aspects described herein may additionally or alternatively be applied to other types of substrates to be coated, stationary dispensing equipment, and other dispensing applications.

The present application contemplates devices, systems and methods for efficiently coating a substrate and for applying a uniform (e.g., in thickness, material properties, etc.) coating on a substrate. According to an inventive aspect of the present application, a dispensing system may include a mobile dispensing device (e.g., a dispensing cart) that is configured to facilitate replacement of depleted fluid reservoirs, for example, to eliminate the need to manually remove the reservoir from the mobile device, or to eliminate the need to transport the mobile dispensing device to a fluid source (e.g., filling station). In an exemplary embodiment, a mobile dispensing device includes a fluid supply module that is detachable from a frame portion of the mobile dispensing device when a fluid stored in the fluid supply module has been depleted, such that a replacement fluid supply module can be installed on the frame portion of the mobile dispensing device.

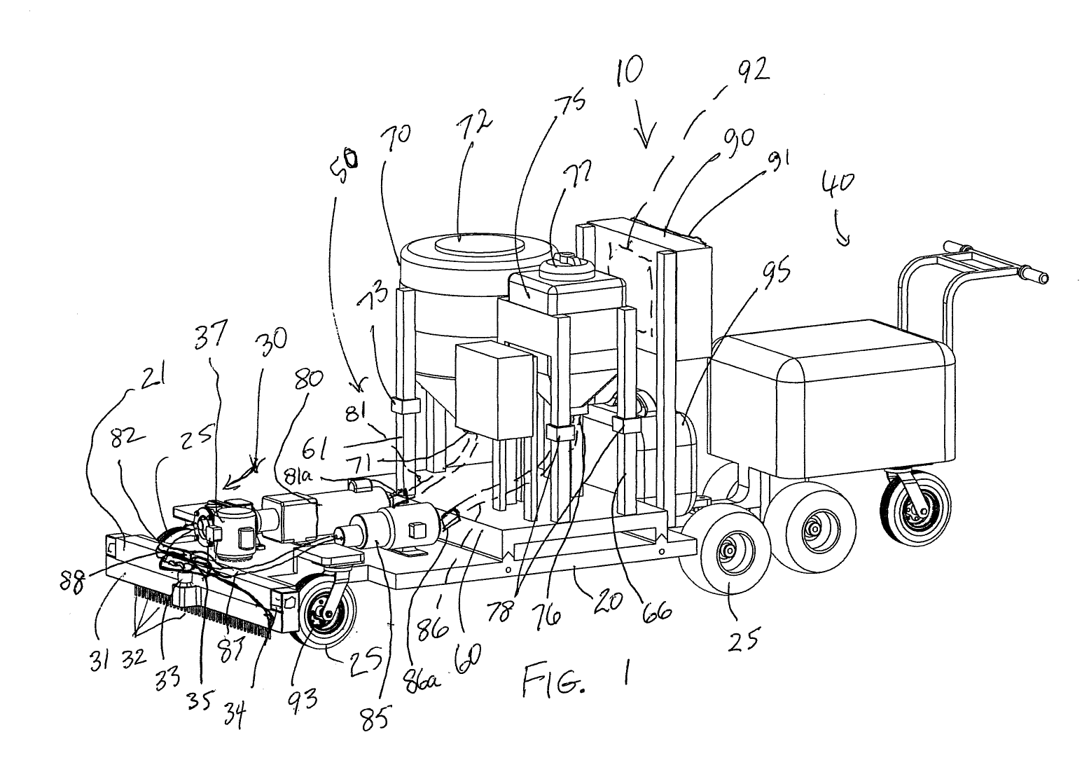

FIG. 1 illustrates an exemplary mobile dispensing device or dispensing cart 10 having a lower platform or frame portion 20 supported by wheels 25 for rolling movement of the cart on a substrate to be coated. The dispensing cart 10 includes a dispensing mechanism 30 at a front end of the cart, a driving mechanism 40 at a rear end of the cart, and a control panel or control cabinet 90 electrically connected with the dispensing mechanism 30 and the driving mechanism 40 for user selected or automatic control of the dispensing and driving systems of the cart 10. The dispensing mechanism 30 and control cabinet 90 are powered by a gas generator 95 mounted to the cart frame 20. In other embodiments, other power sources may additionally or alternatively be utilized, including, for example, an internal battery pack, or cable connection with an external power source.

A fluid supply module 50 is assembled with the frame portion 20 of the dispensing cart 10. The module 50 includes a platform or base member 60 that releasably attaches to the frame portion 20 of the dispensing cart 10. One or more fluid reservoirs or tanks 70, 75, storing fluids to be dispensed, are supported by the base member 60. Removable lids 72, 77 on the tanks 70, 75 permit refilling of the tanks. While the tanks may be supported directly by the base member, in the illustrated embodiment, the tanks 70, 75 are held in place by stands 61, 66 assembled with the base member 60, elevating the tanks to facilitate gravity drainage of fluids through bottom outlet ports 71, 76 of the tanks. The bottom outlet ports 71, 76 are connected (e.g., by hoses 81, 86) with pumps 80, 85 (e.g., gear pumps, diaphragm pumps, centrifuge pumps, etc.) or other flow control mechanisms to supply controlled amounts of the stored fluids to the dispensing mechanism 30 (e.g., via hoses 82, 87 connecting the pumps with the dispensing mechanism). While the pumps may be mounted to the fluid supply module (e.g., directly mounted to the tanks), in the illustrated embodiment, the pumps 80, 85 are mounted to the dispensing cart frame 20, such that separate pumps are not required for each fluid supply module 50 used by the system. Hoses 81, 86 with self-sealing quick disconnect couplings 81a, 86a may be used to connect the tanks 70, 75 to the pumps 80, 85, to facilitate quick, leak-free attachment and detachment.

The cart 10 may be provided with a variety of driving mechanisms, including purely manual (e.g., handle arrangement for pushing and pulling the cart), electromechanical (user steerable, motor powered driving mechanisms), fully motor powered (not pushed or pulled by the operator), and remotely operated or robotic driving mechanisms. In the illustrated embodiment, the driving mechanism 40 includes a motorized cart pushing apparatus, including a motor-driven geared transmission for assisting user pushing and/or pulling of the cart, as described, for example, in U.S. Pat. No. 5,439,069 (the entire contents of which are incorporated herein by reference). Exemplary cart pushing apparatuses include the Cart Caddy, manufactured by DJ Products, and the Power Pusher, manufactured by NuStar. The driving mechanism may be powered by the gas generator 95, or by a power supply internal to the cart pushing apparatus (e.g., battery or separate gas powered generator).

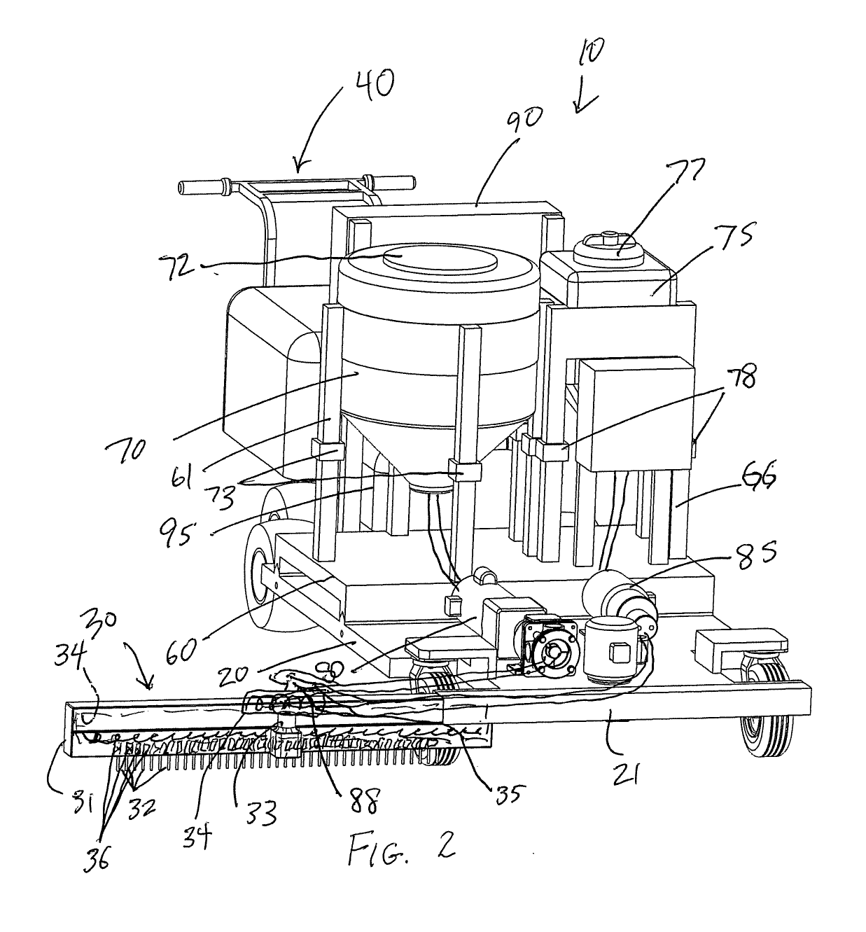

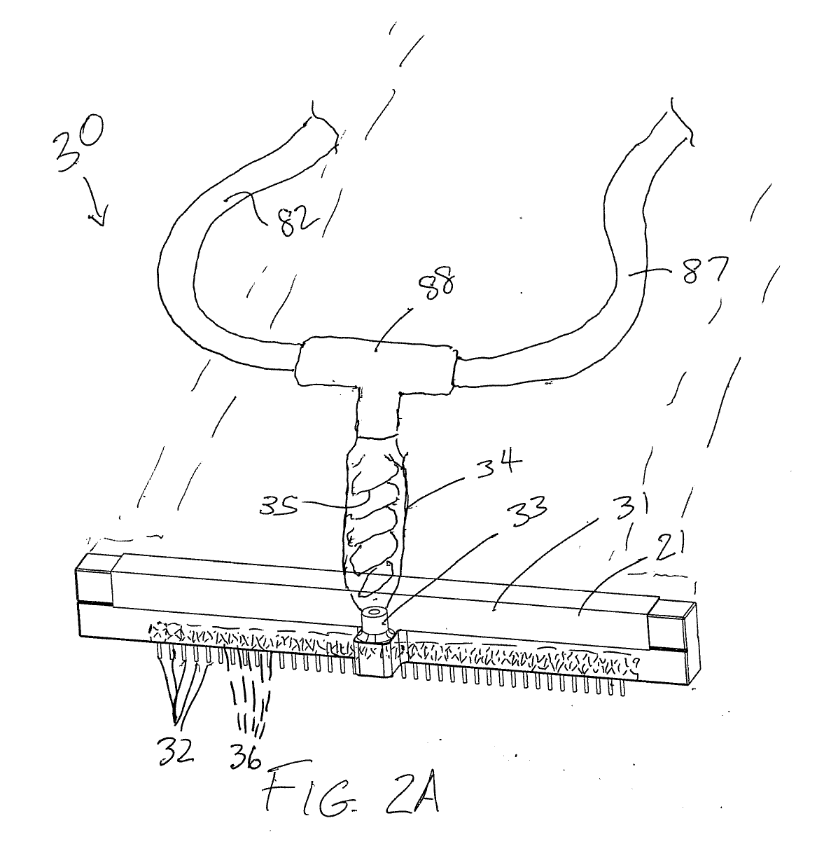

As best shown in FIG. 2A, the exemplary dispensing mechanism 30 includes a dispensing bar 31 at the front end of the dispensing cart, and a fluid inlet port 33 connected with hoses 82, 87 (e.g., by a tee coupling 88) to receive fluids supplied from the pumps. An array of nozzles 32 are arranged laterally along the dispensing bar 31 to apply (e.g., by spraying, diffusing, sprinkling or spreading) the fluid to the substrate.

While the supplied fluids may pass directly from the pumps through the hoses and to the nozzles 32 to dispense the fluids onto the substrate, according to an exemplary aspect of the present application, a mixing unit 34 (e.g., a reservoir, injection block, coupling, etc.) may be connected between the hoses 82, 87 and the dispensing bar 31 to sufficiently mix the supplied fluids before dispensing the fluids from the nozzles. In various embodiments, the mixing unit may be mounted to the dispensing cart frame, attached to the dispensing bar, or integral with the dispensing bar. In the illustrated embodiment, the mixing unit 34 is attached to an upper surface of the dispensing bar 31. In one embodiment, the mixing unit 34 may be provided as a disposable component attached to the dispensing bar 31, to eliminate the need for cleaning or decontaminating the mixing unit.

The mixing unit 34 may include a mixing mechanism for mixing two or more fluids supplied from the fluid tanks 70, 75 to the dispensing mechanism 30. In the illustrated embodiment, the mixing mechanism is a static mixer 35, which may be disposable along with the mixing unit 34. In other embodiments, the mixing mechanism may include a power mixer (which may be provided with a disposable plastic liner or housing for ease of cleaning/decontamination) and an impeller, or may include driving or fluid driven fingers to increase mixing of more viscous materials.

In some embodiments, it may be undesirable to push the dispensing cart over a newly coated portion of the substrate. While the dispensing cart may be pulled (instead of pushed) to avoid having the dispensing cart wheels immediately roll over the coated surface, in an exemplary embodiment, the dispensing mechanism may be arranged to extend laterally outward of the dispensing cart wheels, such that the wheels do not roll over the portion of the substrate being coated. According to another aspect of the present application, a dispensing mechanism of a dispensing cart may include a dispensing bar that is laterally movable to position the dispensing bar at a desired position laterally offset from the dispensing cart frame. When the dispensing cart is not in use, the dispensing bar may be moved to a centered position to minimize the width of the cart.

In the illustrated embodiment, the dispensing cart frame 20 includes a front end bracket 21 that retains the dispensing bar 31 and permits lateral movement of the dispensing bar with respect to the dispensing cart frame 20. In one embodiment, the dispensing bar may be manually slideable within the bracket to a desired offset position (e.g., either to the left side or to the right side, partially or fully offset from the frame) by the user, as shown in FIG. 2. A latch (e.g., mechanical, electromechanical, or magnetic) may be used to secure the dispensing bar in the desired position. In another embodiment, as illustrated) a gear motor 37 may be utilized for powered movement of the dispensing bar 31 to a desired lateral offset position, as selectively or automatically controlled by the control cabinet 90 and powered by the power source 95.

According to another aspect of the present application, a dispensing area or zone of the dispensing mechanism 30 may be controlled to further limit the substrate surface on which the coating is applied. As one example, where a dispensing bar is laterally movable on the dispensing cart frame, a portion of the dispensing cart (e.g., the front end bracket 21) may be configured to block or seal any nozzles 32 that are not positioned laterally outward of the dispensing cart frame 20. As another example, the nozzles 32 may be provided with manually or electronically operated shutoff valve 36, connected with individual nozzles or with groups of nozzles, for selective control of the dispensing zone (e.g., by shutting off laterally outermost nozzles to provide a narrower dispensing zone).

Other dispensing mechanisms may additionally or alternatively be utilized, including, for example, a handheld or adjustably positionable dispensing wand or gun (not shown), for example, to dispense fluid into more restricted or confined areas through which the dispensing cart is unable to pass.

The control cabinet 90 may include a user interface 91 (e.g., touch screen, and/or one or more buttons, knobs, or other mechanisms) operable to control the speed of the pumps 80, 85 and/or the size of the flow apertures (e.g., by utilizing flow regulating shutoff valves 36) to apply a desired thickness and mix ratio of fluid onto the substrate over which the cart travels. Additionally or alternatively, the control cabinet 90 may include an internal controller 92 (e.g., a program logic controller, or PLC) configured to control the pump speeds in accordance with predetermined or user defined coating settings (e.g., thickness, mix ratio, etc.), for example, in order to provide a uniform coating across the surface of the substrate. As such, user operation of the interface 91 can allow for selection of a desired coating thickness (which may be limited to a range between a minimum selectable coating thickness and a maximum selectable coating thickness, depending, for example, on fluid viscosity and other variables), which is correlated to a corresponding flow rate by the internal controller 92, which controls the pump speeds and/or flow apertures to provide the corresponding flow rate.

According to an exemplary aspect of the present application, the controller 92 may be configured to adjust the pump speeds and/or flow apertures in response to rate of movement of the dispensing cart 10 (e.g., due to changes in push speed applied by the user). In the illustrated embodiment, the dispensing cart includes a speed sensor 93 (e.g., a wheel encoder assembled with at least one of the dispensing cart wheels 25) in circuit communication with the controller 92 to transmit movement data to the controller. When the movement data indicates to the controller that the dispensing cart has sped up, the controller operates to increase the speed of the pumps 80, 85 and/or the size of the flow apertures, increasing the flow rate from the dispensing mechanism 30 to maintain a substantially uniform coating on the portion of the substrate over which the dispensing cart moves more quickly. When the movement data indicates to the controller that the dispensing cart has slowed down, the controller operates to reduce the speed of the pumps 80, 85 and/or the size of the flow apertures, reducing the flow rate from the dispensing mechanism 30 to maintain a substantially uniform coating on the portion of the substrate over which the dispensing cart moves more slowly. When the movement data indicates to the controller that the dispensing cart has stopped, the controller operates to shut off the pumps 80, 85 to prevent excess coating at that location.

The controller 92 may be configured to associate a predetermined speed of the pump 80, 85 and/or size of the flow apertures with a corresponding flow rate of fluid from the corresponding fluid tank 70, 75. In some applications, deviations in the expected flow rate may result from a variety of conditions, including, for example, variations in viscosity of the fluid (as affected, for example, by changes in temperature), leakage from the hoses or pumps, buildup of sediment or solidified fluid in the hose connections, or kinks in the hoses. These deviations may result in an insufficient coating thickness or an improper mix ratio when one of two or more fluids being mixed is being supplied at an insufficient rate. According to an exemplary aspect of the present application, a dispensing device may be provided with a flow measuring mechanism that directly or indirectly measures a rate of fluid flow (e.g., from a fluid tank, through a supply pump or other flow control mechanism, through a mixing unit, or through a dispensing mechanism). The flow measuring mechanism transmits the flow rate indicating data to a controller (e.g., a program logic controller or PLC), which may store or transmit this flow rate data for concurrent or future analysis. The controller may also compare this fluid flow data with a predetermined or expected flow rate based on a setting of the flow control mechanism for the fluid (e.g., a pump speed setting for a pump). In response to any deviations from the predetermined or expected flow rate, as determined by the controller, the controller may generate an alert to the operator or administrator (e.g., a warning light or siren, or a wirelessly transmitted message). Additionally or alternatively, the controller may be configured to adjust the flow control mechanism setting to adjust the actual flow rate of the fluid to correspond to the predetermined or expected flow rate.

While many different flow measuring mechanisms may be utilized (e.g., flow meters, electronic ration monitoring equipment for measuring fluid dielectric data), in one embodiment, one or more load cells may be used to measure changes in the total weight of a fluid tank over time for determination of the flow rate. In the illustrated embodiment, the tank stands 61, 66 are provided with load cells 73, 78 in circuit communication with the controller 92 for measuring and transmitting load data (continuously or at predetermined intervals) to the controller. When the load data indicates to the controller that the fluid flow rate from a fluid tank 70, 75 is lower than expected (i.e. the weight or mass of the fluid tank is decreasing more slowly than expected), the controller 92 may operate to increase the speed of the corresponding pump 80, 85 and/or the size of the flow apertures, increasing the flow rate of the fluid to the dispensing mechanism 30 to maintain a substantially uniform mix ratio of the dispensed fluid. When the load data indicates to the controller that the fluid flow rate from a fluid tank 70, 75 is higher than expected (i.e. the weight or mass of the fluid tank is decreasing more rapidly than expected), the controller 92 may operate to reduce the speed of the corresponding pump 80, 85 and/or the size of the flow apertures, reducing the flow rate of the fluid to the dispensing mechanism 30 to maintain a substantially uniform mix ratio of the dispensed fluid. When detecting such a deviation, the controller 92 may be configured to additionally or alternatively (i.e., without making flow rate adjustments) provide an alert to the user (e.g., a light or siren activated on the control cabinet 90), for example, to check the dispensing cart for hose kinks or blockages. When the load data indicates to the controller 92 that the fluid flow rate from the fluid tank 70, 75 deviates from an expected flow rate by an excessive amount (as defined by the controller), the controller may immediately shut down the dispensing cart and provide an alert to the user. As bumps during cart movement may produce large instantaneous load cell deviations, the controller may be configured to monitor deviations over a brief predetermined time period (e.g., 1 to 5 seconds) before making any adjustments to the pump speed.

The load cells 73, 78 may additionally or alternatively provide load data to the controller 92 to indicate when either of the fluid tanks 70, 75 have reached a low or depleted condition, by comparing the load data to weight information corresponding to this depleted condition. The controller 92 may be configured to alert the user (e.g., through an indicator light or siren) when either of the fluid tanks have reached this depleted condition, so that the user may initiate refilling or replacement of the fluid supply module 50.

The controller 92 may additionally or alternatively perform additional analysis, monitoring, and quality control functions for the dispensing system. For example, the controller may be connected to a bar code scanner, RFID reader or other data receiving mechanism configured to obtain information from the fluid tanks or the fluid supply module, for example, to verify that the correct fluid tanks are being connected with the dispensing mechanism (and to shut off or disable the device if the incorrect fluids are provided). As discussed above, the controller may convert mass dispensed (as determined by load cell data signals) to volume dispensed, and based on measured cart movement (for example, determined by wheel encoders or other speed sensors, determine average coverage rate, material applied over estimated area. The controller, using an internal clock, may determine dispensing time, job efficiency, and corresponding job site performance parameters. The controller may store and/or transmit any of this job performance data to provide manufacturing to application documentation tracking.

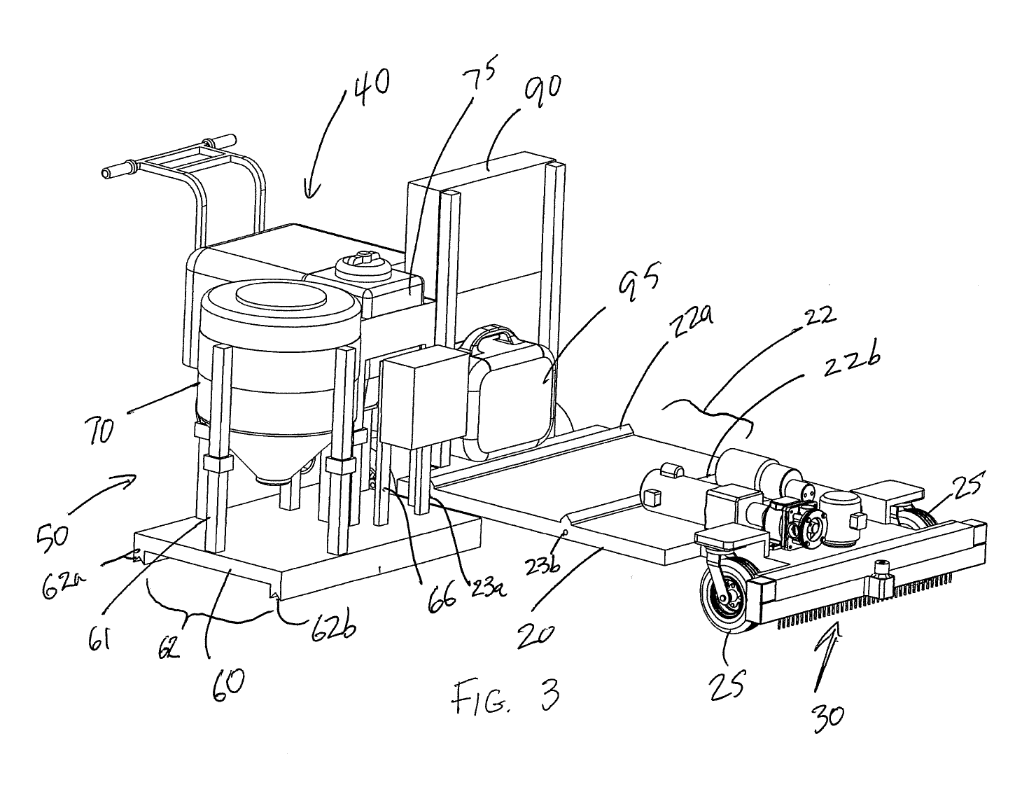

Many different arrangements may be utilized for releasably attaching the fluid supply module to the frame of the dispensing cart, for example, for refilling or replacement. In one embodiment, an upper surface of the dispensing cart frame includes a dispensing cart track portion (e.g., one or more rails, slots, grooves, or lines of wheels or bearings) configured for sliding, interlocking engagement with a complementary shaped module track portion (e.g., one or more rails, slots, grooves, or lines of wheels or bearings) on a bottom surface of the fluid supply module. In the illustrated embodiment, as shown in FIG. 3, the dispensing cart frame 20 includes a dispensing cart track portion 22 comprising a pair of v-shaped rails 22a, 22b, and the base member 60 of the fluid supply module 50 includes a module track portion 62 comprising a pair of complementary v-shaped grooves or slots 62a, 62b. In other embodiments, the number and shape of the rails and grooves (or other suitable track portions) may be varied. In the illustrated embodiment, the rails 22a, 22b and grooves 62a, 62b extend substantially parallel to the axes of rotation of the dispensing cart wheels 25, for lateral sliding engagement (and disengagement) of the module 50 and the mobile dispensing device frame 20. In other embodiments (not shown), the track portions may extend substantially perpendicular to the wheel axes, for longitudinal sliding engagement (and disengagement) of the module 50 and the mobile dispensing device frame 20.

Many different fastening arrangements may be utilized to securely attach the fluid supply module to the dispensing cart. For example, the rails and slots may be provided with an interlocking shape (e.g., a tongue and groove shape) in cross-section, thereby preventing the attached fluid supply module from being lifted out of engagement from the dispensing cart frame. As another example, at least one of the module and the dispensing cart may be provided with one or more latch mechanisms (e.g., a mechanical latch, magnetic latch, or electromechanical latch) configured to secure the module to the dispensing cart against sliding disengagement of the module track portion from the dispensing cart track portion. When detachment of the fluid supply module from the dispensing cart is desired, the one or more latches may be operated to release the module from the dispensing cart.

While a fluid supply module may be manually lifted into place on the mobile dispensing device by a user, in many applications, the weight of the module itself combined with the weight of the contained fluid may make the module difficult to lift and transport. According to another exemplary aspect of the present application, a mobile fluid transport device (e.g., a transport cart) may be utilized to transport the fluid supply module to the mobile dispensing device. In one such embodiment, a mobile fluid transport device is provided with a track portion configured for sliding and interlocking engagement with the track portion of the fluid supply module. The mobile fluid transport device may be maneuvered into alignment with the mobile dispensing device, such that the transport cart track portion aligns with the dispensing cart track portion. This alignment allows the module track portion to be directly slid out of engagement with the transport cart track portion and into engagement with the dispensing cart track portion on the dispensing cart frame.

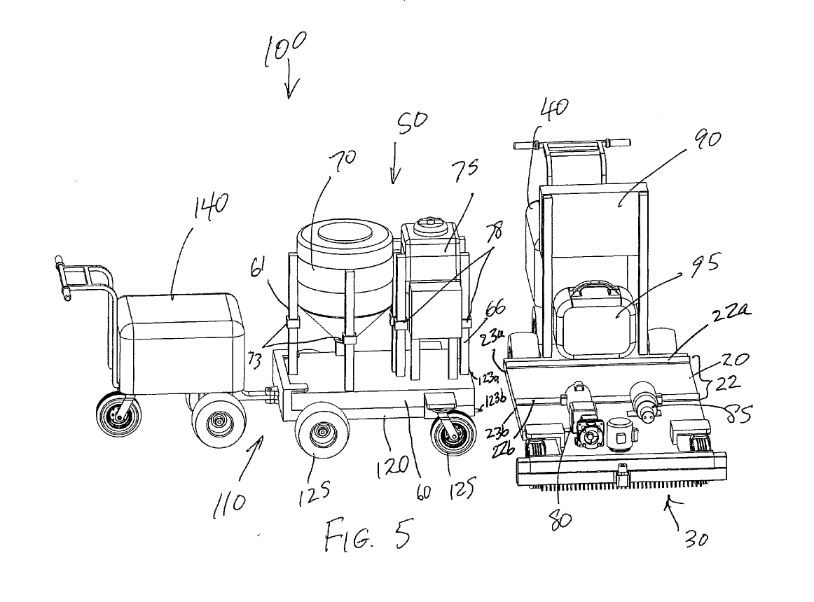

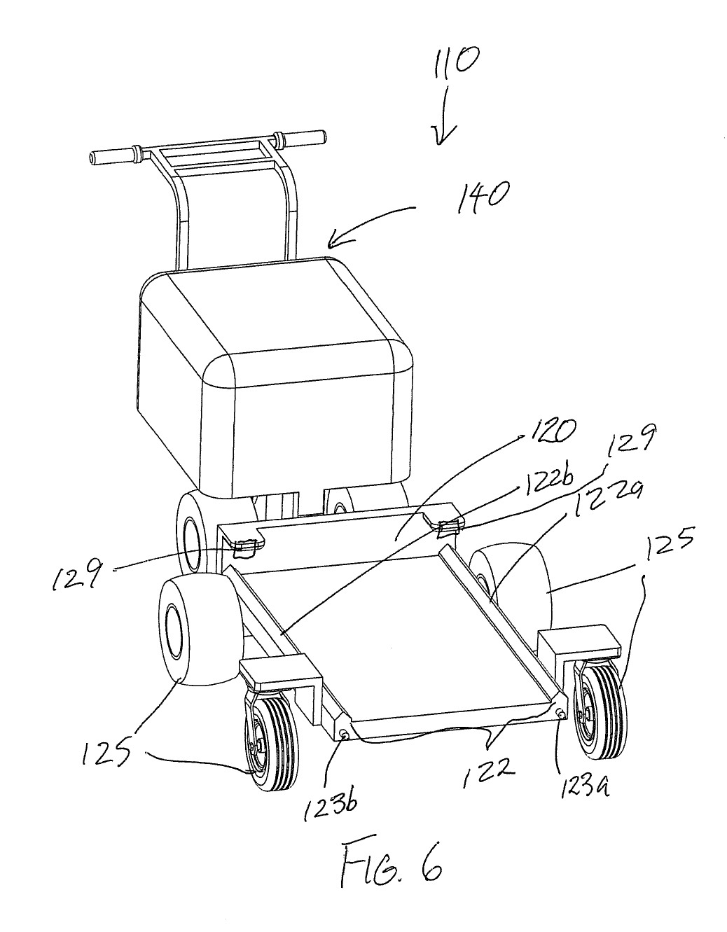

FIG. 5 illustrates a dispensing system 100 including the mobile dispensing device 10 and the fluid supply module 50 of FIGS. 1 and 2, and with a mobile fluid transport device or transport cart 110 having a lower platform or frame portion 120 supported by wheels 125 for rolling movement of the transport cart on the substrate to be coated. The transport cart 110, also shown in FIG. 6, includes a driving mechanism 140 at a rear end of the cart. Because the transport cart 110 is not used to dispense the fluid(s) being carried, the transport cart does not need to be provided with a dispensing mechanism, pumps, or control cabinet.

The cart 110 may be provided with a variety of driving mechanisms, including purely manual (e.g., handle arrangement for pushing and pulling the cart), electromechanical (user steerable, motor powered driving mechanisms), fully motor powered (not pushed or pulled by the operator), and remotely operated or robotic driving mechanisms. In the illustrated embodiment, the driving mechanism 140 includes a motorized cart pushing apparatus, as described above, powered by a suitable power source (e.g., battery or gas powered generator internal to the cart pushing apparatus).

In the illustrated embodiment, the transport cart frame 120 includes a transport cart track portion 122 comprising a pair of v-shaped rails 122a, 122b at least substantially similar to the v-shaped rails 22a, 22b of the dispensing cart frame 20. In other embodiments, the number and shape of the rails and grooves (or other suitable track portions) may be varied. In the illustrated embodiment, the rails 122a, 122b extend substantially perpendicular to the axes of rotation of the transport cart wheels 125, for longitudinal sliding engagement (and disengagement) of the module 50 and the mobile transport device frame 120. This arrangement allows for maneuvering of the transport cart 110 in an orientation perpendicular to the orientation of the dispensing cart 10 to align the transport cart track portion 122 with the dispensing cart track portion 22, for sliding, rolling, or other such movement of the fluid supply module 50 from the transport cart 110 to the dispensing cart 10 (or for movement of a depleted fluid supply module from the dispensing cart to the transport cart). In other embodiments (not shown), the transport cart track portion may extend substantially parallel to the transport cart wheel axes, for lateral sliding engagement (and disengagement) of the module and the transport cart frame. This alternate arrangement would allow for maneuvering of the transport cart in an orientation parallel to (i.e., side-by-side with) the orientation of the dispensing cart to align the transport cart track portion with the dispensing cart track portion of, for sliding, rolling, or other such movement of the fluid supply module from the transport cart to the dispensing cart (or from the dispensing cart to the transport cart).

In another embodiment (not shown), a transport cart may include a second track portion (which may be identical to the first track portion on the transport cart frame) for retaining a second fluid supply module. In such an embodiment, the transport cart may be configured to receive a depleted fluid supply module from the dispensing cart (e.g., onto the second track portion), and then transport a replacement fluid supply module to the dispensing cart, without having to first return to a refilling location to refill the depleted module.

Many different fastening arrangements may be utilized to securely attach the fluid supply module to the transport cart. For example, the rails and slots (or other types of track portions) may be provided with an interlocking shape (e.g., a tongue and groove shape) in cross-section, thereby preventing the attached fluid supply module from being lifted out of engagement from the transport cart frame. As another example, at least one of the module and the transport cart may be provided with one or more latch mechanisms (e.g., a mechanical latch, magnetic latch, or electromechanical latch) configured to secure the module to the transport cart against sliding disengagement of the module track portion from the transport cart track portion. When detachment of the fluid supply module from the transport cart is desired, the one or more latches may be operated to release the module from the transport cart.

To facilitate alignment of the dispensing cart track portion 22 and the transport cart track portion 122, the dispensing cart 10 and transport cart 110 may be provided with mating alignment features that interengage to maintain alignment of the track portions. While many different types of alignment features may be utilized, in the illustrated embodiment, a front surface of the transport cart frame 120 is provided with first and second alignment pins 123a, 123b (see FIG. 6), and a side surface of the dispensing cart frame 20 is provided with first and second alignment bores 23a, 23b sized and positioned to receive the alignment pins 123a, 123b for alignment of the transport cart track portion 122 with the dispensing cart track portion 22 for sliding movement of the fluid supply module 50 from the transport cart 110 to the dispensing cart 10.

In an exemplary method of replacing a depleted fluid supply module 50 of a dispensing cart 10 with a replacement (e.g., filled) fluid supply module 50, an unloaded (e.g., without a fluid supply module) transport cart 110 is pushed, driven, or otherwise transported to the dispensing cart 10, and maneuvered to orient the transport cart such that the transport cart track portion 122 aligns with the dispensing cart track portion 22 (e.g., by engaging the alignment pins 123a, 123b of the transport cart frame 120 with the alignment bores 23a, 23b of the dispensing cart frame 20). The hoses 81, 86 connecting the tanks 70, 75 to the dispensing mechanism 30 are disconnected (e.g., using self-sealing quick disconnect couplings) from the pumps 80, 85. The depleted fluid supply module 50 is released from the dispensing cart 10 (e.g., by manually or electronically releasing one or more latches, shown schematically at 129 in FIG. 6) securing the module to the dispensing cart), and the fluid supply module is slid onto the transport cart 110 (with the module track portion 62 slidingly disengaging from the dispensing cart track portion 22 and slidingly engaging the transport cart track portion 122.

After the transport cart 110 and depleted fluid supply module 50 are transported away from the dispensing cart 10, a transport cart 110 (either the same transport cart or a second transport cart) carrying a filled fluid supply module 50 (either the same fluid supply module, after refilling, or a second fluid supply module) is pushed, driven, or otherwise transported to the dispensing cart 10, and maneuvered to orient the transport cart 110 such that the transport cart track portion 122 aligns with the dispensing cart track portion 22 (e.g., by engaging the alignment pins 123a, 123b of the transport cart frame 120 with the alignment bores 23a, 23b of the dispensing cart frame 20). The filled fluid supply module 50 is released from the transport cart 110 (e.g., by manually or electronically releasing one or more latches securing the module 50 to the transport cart 110), and the fluid supply module 50 is slid onto the dispensing cart 10 (with the module track portion 62 slidingly disengaging from the transport cart track portion 122 and slidingly engaging the dispensing cart track portion 22. The hoses 81, 86 connected to the tanks 70, 75 are connected (e.g., using self-sealing quick disconnect couplings) to the pumps 80, 85 to connect the tanks to the dispensing mechanism 30.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, hardware, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

While the present invention has been illustrated by the description of embodiments thereof, and while the embodiments have been described in considerable detail, it is not the intention of the applicant to restrict or in any way limit the scope of the invention to such detail. Additional advantages and modifications will readily appear to those skilled in the art. For example, the specific locations of the component connections and interplacements can be modified. Therefore, the invention, in its broader aspects, is not limited to the specific details, the representative apparatus, and illustrative examples shown and described. Accordingly, departures can be made from such details without departing from the spirit or scope of the applicant's general inventive concept.

1. A mobile dispensing device comprising:
a frame supported by at least one wheel for rolling movement of the frame on a substrate, the frame including a first track portion;
a dispensing mechanism carried by the frame; and
a fluid supply module including a base member and at least one tank carried by the base member and connectable with the dispensing mechanism for dispensing a fluid stored in the at least one tank, the base member having a second track portion releasably engageable with the first track portion of the frame for releasable assembly of the fluid supply module with the frame.

2. The mobile dispensing device of claim 1, wherein one of the first and second track portions comprises at least one rail, and the other of the first and second track portions comprises at least one slot sized and positioned for sliding engagement with the at least one rail.

3. The mobile dispensing device of claim 1, further comprising a pump mounted to the frame, the pump being releasably connected to the at least one tank and in fluid communication with the dispensing mechanism for pumping fluid stored in the at least one tank to the dispensing mechanism.

4. The mobile dispensing device of claim 3, further comprising a controller electrically connected with the pump for controlling a speed of the pump according to a predetermined flow rate.

5. The mobile dispensing device of claim 4, further comprising a speed sensor configured to transmit data to the controller corresponding to a speed of movement of the mobile dispensing device, wherein the controller is configured to adjust the pump speed in response to changes in the speed of movement of the mobile dispensing device.

6. The mobile dispensing device of claim 1, wherein the dispensing mechanism comprises a dispensing bar secured to a front end of the frame, the dispensing bar including a plurality of nozzles.

7. The mobile dispensing device of claim 6, wherein the dispensing bar is laterally slideable with respect to the frame, such that the dispensing bar is positionable in a laterally offset position in which at least one of the plurality of nozzles is positioned laterally outward of the frame.

8. The mobile dispensing device of claim 1, wherein the dispensing bar is laterally slideable with respect to the frame, such that the dispensing bar is positionable in a laterally offset position in which all of the plurality of nozzles are positioned laterally outward of the frame.

9. The mobile dispensing device of claim 1, wherein the first track portion extends substantially parallel to a rotational axis of the at least one wheel.

10.-15. (canceled)

16. A method for supplying fluid to a mobile dispensing device including a frame supported by at least one wheel for rolling movement of the frame on a substrate and a dispensing mechanism carried by the first frame, the method comprising:
providing a fluid transport device including a frame supported by at least one wheel for rolling movement of the second frame on the substrate, and a fluid supply module including a base member, a first track portion engaged with a second track portion of the fluid transport device frame, and at least one tank carried by the base member;
moving the fluid transport device to a loading position proximate the mobile dispensing device, such that the second track portion of the fluid transport device frame aligns with a third track portion on the mobile dispensing device frame;
releasing the first track portion of the fluid supply module from the second track portion of the fluid transport device frame;
sliding the fluid supply module onto the mobile dispensing device frame, such that the first track portion of the fluid supply module engages the third track portion of the mobile dispensing device frame; and
connecting the at least one tank with the dispensing mechanism of the mobile dispensing device for dispensing a fluid stored in the at least one tank.

17. The method of claim 16, wherein moving the fluid transport device to the loading position comprises interengaging a first alignment feature of the first frame with a second alignment feature of the second frame.

18. The method of claim 17, wherein one of the first and second alignment features comprises at least one pin, and the other of the first and second alignment features comprises at least one bore sized and positioned to receive the at least one pin.

19. A dispensing device for dispensing at least a first fluid, the dispensing device comprising:
a frame;
a dispensing mechanism carried by the frame;
a first fluid tank supported by the frame and connected with the dispensing mechanism;
a first load sensing mechanism connected with the first fluid tank for generating first load data corresponding to a weight of a first fluid disposed in the first fluid tank;
a first flow control mechanism operable to control flow of the first fluid from the first fluid tank to the dispensing mechanism; and
a controller in circuit communication with the first load sensing mechanism and with the first flow control mechanism, the controller being operable to:
measure a first flow rate of the first fluid based on changes to the first load data over a predetermined time period;
compare the first flow rate to first fluid parameters stored by the controller; and
control the first flow control mechanism to adjust the first flow rate to correspond with the first fluid parameters.

20. The dispensing device of claim 19, wherein the frame is supported by at least one wheel for rolling movement of the frame on a substrate.

21. The dispensing device of claim 20, further comprising a speed sensor configured to transmit data to the controller corresponding to a speed of movement of the dispensing device, wherein the controller is configured to further control the first flow control mechanism in response to changes in the speed of movement of the dispensing device.

22. The dispensing device of claim 19, wherein the first flow control mechanism comprises a pump.

23. The dispensing device of claim 19, wherein the first flow control mechanism comprises a gear pump.

24. The dispensing device of claim 19, wherein the first flow control mechanism comprises at least one regulating valve operable to control a size of a flow aperture in the at least one regulating valve.

25.-39. (canceled)
